(19) United States
(12) Patent Application Publication
(10) Pub. No.: US 2026/0264385 A1
(43) Pub. Date: Sep. 10, 2026

(54) Six-roller coating mechanism and laminating device thereof

(71) Applicant: Chongqing Sinstar Packaging Machinery Co., Ltd., Chongqing (CN)

(72) Inventors: Kai LI, Chongqing (CN); Heng ZHENG, Chongqing (CN); Yongcai LI, Chongqing (CN); Yuehua CHEN, Chongqing (CN); Chaojian LUO, Chongqing (CN)

(73) Assignee: Chongqing Sinstar Packaging Machinery Co., Ltd., Chongqing (CN)

(21) Appl. No.: 18/994,850

(22) PCT Filed: Apr. 21, 2023
(86) PCT No.: PCT/CN2023/089787

§ 371 Date: Jan. 15, 2025

(30) Foreign Application Priority Data
Dec. 29, 2022 (CN) 202223551335.1

(51) Int. Cl. B32B 37/00; B32B 38/00

(52) U.S. Cl. CPC B32B 37/0053; B32B 38/1875; B32B 2038/0052

(57) ABSTRACT

A six-roller spreading mechanism and a laminator having the same. The laminator comprises a new six-roller spreading mechanism, which comprises a metering roller, a transfer steel roller, a transfer rubber roller, a spreading steel roller, a spreading rubber roller and a spreading pressure roller, wherein the spreading rubber roller is movably connected to a base by means of a linear motion mechanism so as to enable the spreading rubber roller to linearly move on the base. The new six-roller spreading mechanism is used by the laminator. The active linear motion mechanism is connected to the spreading rubber roller to enable the spreading rubber roller to move linearly, such that control over an acting force between the spreading rubber roller and the spreading pressure roller and the spreading steel roller is achieved, thereby solving the problem of slipping caused by using a low-viscosity glue, also solving the additional problem of the feeding amount of the glue, and thus improving the spreading quality.

### TECHNICAL FIELD

The present invention relates to the technical field of packaging devices, specifically a six-roller coating mechanism and laminating device thereof.

### BACKGROUND TECHNOLOGY

In the packaging technical field, a laminating machine is a compulsory apparatus, and a laminating machine is to laminate two or more layers of materials together, in conventional laminating machines, coating is done in one machine and then the material is transmitted to another machine for laminating, along with technological development and industrial demands for compactness, a complex machine for coating and laminating on one pedestal has gradually been developed, for example, the Applicant has disclosed a technical solution in China patent application number 201310326676.5 entitled a laminating machine and laminating method, wherein the laminating machine comprises a first pedestal, a coating assembly and a laminating assembly are provided on the first pedestal, and coating and laminating on the same pedestal is realized.

For such kind of coating assembly usually five-roller coating assemblies are used, however, with the extension of packaging requirements, and revealing of issues during fabrication of the five-roller coating assemblies, the Applicant proposed a six-roller coating and laminating pedestal in China patent application number 202120109700X, and in the six-roller coating and laminating pedestal, by configuration of an alignment roller (the coating pressure roller in the present invention), deformation of the coating rubber roller is avoided to address the problem occurred during five-roller coating.

When using the six-roller coating assembly, as the coating pressure roller in the six-roller coating mechanism is connected with an oscillating arm, pressure of the coating pressure roller during coating is adjusted by the oscillating arm, while the coating rubber roller is fixed and rotatable via contact friction between rollers, during use, when glues of a low viscosity are used, slippery connection may occur, gluing quality of the material roll may be affected, so is the coating and laminating quality. Therefore, in view of this issue, the Applicant provides a six-roller coating mechanism and a laminating machine.

### SUMMARY OF THE INVENTION

In view of the deficiencies in the prior art, the present invention provides a six-roller coating mechanism and a laminating machine, to address the problem of uniform gluing of the glues of a low viscosity, the coating quality of the material roll when coating using the glues of a low viscosity is thus improved, and the laminating quality of the product is improved.

To reach the foregoing purpose, the present invention provides a six-roller coating mechanism, comprises a base frame, a metering roller, a transfer steel roller, a transfer rubber roller, a coating steel roller, a coating rubber roller, and a coating pressure roller, the coating rubber roller is movably connected on the base frame via a linear motion mechanism so to enable the coating rubber roller to make linear movement on the base frame.

For the proposed six-roller coating mechanism, by configuring the coating rubber roller to be a linear motion mechanism and providing the linear motion mechanism actively driven, with the coating rubber roller in between the coating pressure roller and the coating steel roller, when the coating rubber roller moves forces in between the coating steel roller and the coating pressure roller will be affected, forces in between the coating rubber roller and two adjacent rollers will act on a quantity of glue adhered on the coating rubber roller, gluing of a material roll will be subsequently affected, in this way, the slippery problem can be addressed by adjusting the forces in between the coating rubber roller and the two adjacent rollers, and the problem that the gluing quantity of glues of a low viscosity is addressed.

Further, the coating pressure roller is connected on the base frame. As the coating rubber roller can be used to adjust the force against the coating pressure roller which is higher in position and force on the coating steel roller which is lower in position, the coating pressure roller is configured to be fixed in shape, and rotatable in fixed positions.

Further, a guiding portion is provided on the base frame, so that the coating rubber roller is movable along the guiding portion and is abutted against the coating pressure roller and the coating steel roller, the guiding portion comprises a guiding groove or a guiding sliding rail, and the coating rubber roller is installed in the guiding groove or the coating rubber roller is installed on the guiding sliding rail. The guiding groove is an open structure, which makes it convenient to detach the coating rubber roller and assembly ease of the coating rubber roller is good.

Further, the mechanism further comprises an introduction roller for inputting the material roll provided on the base frame next to the coating rubber roller.

According to an aspect of the present invention, when the material roll enters the base frame from a left side, the transfer steel roller, the coating steel roller and the coating pressure roller rotate in a counterclockwise direction, and the transfer rubber roller and the coating rubber roller rotate in a clockwise direction. Where the base frame in the present invention is located to a right portion of the material roll, the material roll entering the base frame from the left portion for coating, in this way, by limiting rotation directions of the rollers, smooth coating of the material roll can be realized, as shown in FIG. 1.

According to another aspect of the present invention, where the material roll enters the base frame from the right portion, the transfer steel roller, the coating steel roller and the coating pressure roller rotate in a clockwise direction, and the transfer rubber roller and the coating rubber roller rotate in a counterclockwise direction. Where the base frame is located to a left side of the material roll, the material roll enters the base frame from the right portion for coating, by limiting the rotation directions of the rollers, smooth coating of the material roll can be promised, as shown in FIG. 2. It can be known from the foregoing two methods that the adaptability of the base frame in the present invention is high, and is usable in different machines.

The present invention further provides a laminating machine, wherein the laminating machine comprises the foregoing six-roller coating mechanism.

Further, the laminating machine comprises:
A surface unreel coating frame, comprising a surface layer unreeling mechanism, a surface layer coating assembly and a surface material;
A laminating reeling frame, comprising a bottom layer unreeling mechanism, a bottom layer material, a second laminating portion and a laminating reeling mechanism; and
A coating laminating frame, comprising the six-roller coating mechanism; comprising an intermediate layer unreeling mechanism, an intermediate layer material and a first laminating portion;
   Wherein the surface unreeling coating frame and the six-roller coating mechanism are respectively connected with the laminating frame.

According to the laminating machine, by providing the laminating reeling frame in an intermediate portion, a path for laminating the material roll to finish is reduced, and in the coating and laminating frame, the six-roll coating mechanism and the intermediate layer unreeling mechanism, the intermediate layer material and the first laminating portion are provided, a path for the intermediate layer material is reduced, and can be laminated with the coated bottom layer material, stability of the intermediate layer material can be promised, as aluminum foil material of a small fracture strength will be used for packing the intermediate layer material; and in order to improve laminating quality, the novel six-roller coating mechanism is used so to improve coating quality.

Further, at least one tension roller is provided in between the six-roller coating mechanism and the first laminating portion.

The present invention has at least the following beneficial effects:

By connecting with an active linear movement mechanism on the coating rubber roller, the coating rubber roller can make linear movement, in this way, the force on the coating rubber roller in between the coating pressure roller and the coating steel roller is controlled, slippery due to the use of the glue of a low viscosity can be addressed, the problem of the glue using quantity is solved and the coating quality is improved.

By using the novel six-roller coating mechanism, the laminating product quality is improved.

### BRIEF DESCRIPTION OF DRAWINGS

In order to explain the technical solutions in the embodiments of the present invention or the prior art more clearly, hereinafter the drawings to be used in description of the embodiments and the prior art will be explained briefly. In all the drawings, similar elements or portions are labeled by similar reference numbers. In the drawings, all portions or elements are not necessarily drafted as per actual proportions.

FIG. 1 is a structural diagram showing a six-roller coating mechanism according to an embodiment of the present invention;

FIG. 2 is a structural diagram showing the six-roller coating mechanism according to another embodiment of the present invention;

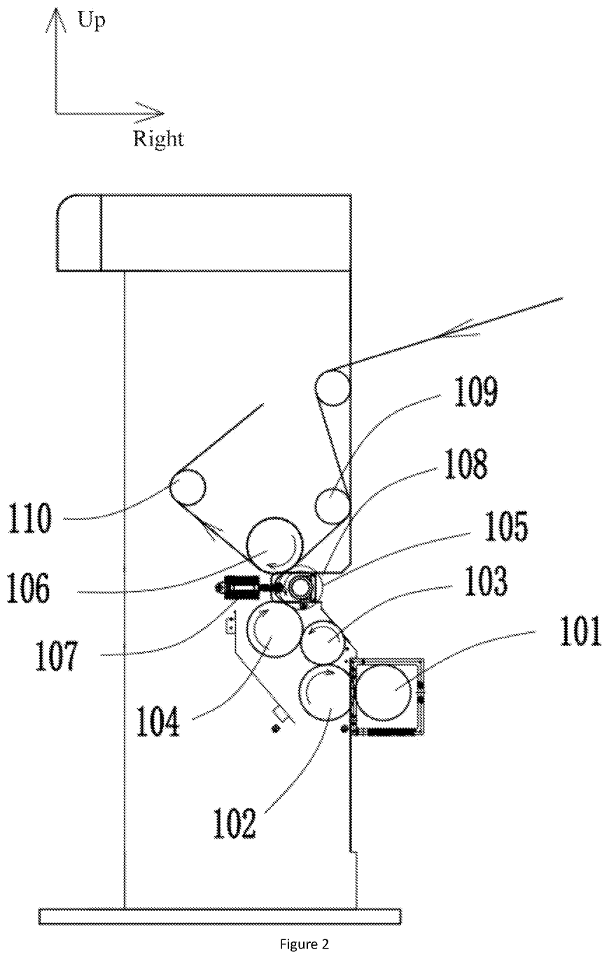

FIG. 3 is a structural diagram showing a laminating machine provided in an embodiment of the present invention; and

FIG. 4 is a structural diagram showing the laminating machine provided in another embodiment of the present invention.

In the drawings, coating and laminating frame 100, metering roller 101, transfer steel roller 102, transfer rubber roller 103, coating steel roller 104, coating rubber roller 105, coating pressure roller 106, linear motion mechanism 107, guiding groove 108, introduction roller 109, tension roller 110, intermediate layer unreeling mechanism 111, intermediate layer material 112, first laminating portion 113, laminating reeling frame 200, bottom layer unreeling mechanism 201, bottom layer material 202, second laminating portion 203, laminating reeling mechanism 204, surface layer unreeling coating frame 300, surface layer unreeling mechanism 301, surface layer material 302, surface layer coating assembly 303 and stand 400.

### EMBODIMENTS

Hereinafter a detailed description to the embodiments of the present invention will be given in conjunction with the drawings. The embodiments are merely given to explain the technical solutions of the present invention and are exemplary, and not intended to limit the protection scope of the present invention.

It shall be noted that, the surface layer and the bottom layer in the present invention are interchangeable, unless indicated expressly otherwise, the technical terms or scientific terms used in the present invention shall have ordinary or general meanings known to those skilled in the art.

### Embodiment

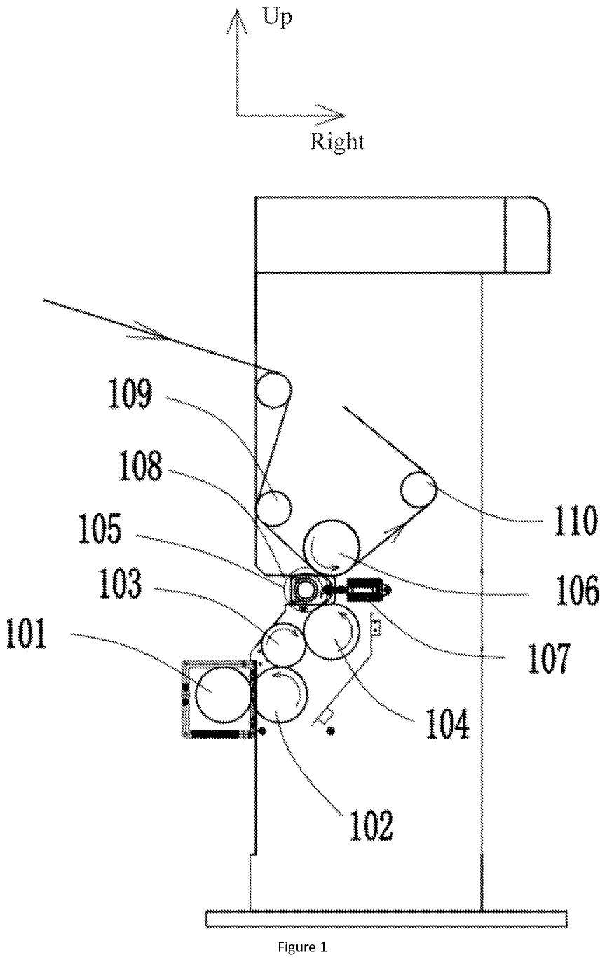

As shown in FIG. 1, a six-roller coating mechanism, comprises a base frame, a metering roller 101, a transfer steel roller 102, a transfer rubber roller 103, a coating steel roller 104, a coating rubber roller 105, and a coating pressure roller 106 are provided at a left portion of the base frame, a guiding groove 108 for installing the coating rubber roller 105 is provided in a side of the base frame, the coating rubber roller 105 is connected movably in the guiding groove 108 via a linear motion mechanism 107 and is supported by the base frame, the linear motion mechanism 107 comprises an air cylinder, so that the coating rubber roller 105 can make linear movement on the base frame, and an introduction roller 109 for inputting a material roll is provided at a side of the base frame close to the coating rubber roller 105; as the entire six-roller coating mechanism is located to a left side, the material roller enters from the left side, the transfer steel roller 102, the coating steel roller 105 and the coating pressure roller 106 rotate in a counterclockwise direction, and the transfer rubber roller 103 and the coating rubber roller 105 rotate in a clockwise direction.

Wherein, the guiding groove 108 can be replaced to be other guiding components for guiding the coating rubber roller to make transverse horizontal movement on the base frame such as a guiding sliding rail, configuring the other guiding components such as the guiding sliding rail can be done by connecting the guiding components or the guiding sliding rail on the base frame and connecting the coating rubber roller slidably on the guiding components or the guiding sliding rail, and the configuration of the guiding sliding rail can be configured by those skilled in the art and is thus not shown in the drawings.

### Embodiment

As shown in FIG. 1, a six-roller coating mechanism, comprising a base frame, wherein a metering roller 101, a transfer steel roller 102, a transfer rubber roller 103, a coating steel roller 104, a coating rubber roller 105 and a coating pressure roller 106, a guiding groove 108 for installing the coating rubber roller 105 is provided at a side of the base frame, the coating rubber roller 105 is movably connected in the guiding roller 108 via a linear motion mechanism 107 and is supported by the base frame, the linear motion mechanism 107 comprises an air cylinder device, so as to have the coating rubber roller 105 to make linear movement on the base frame, and an introduction roller 109 for inputting the material roll is provided at a side of the base frame close to the coating rubber roller 105; as the entire six-roller coating mechanism is located to the right side, the material roll enters from the right side, the transfer steel roller 102, the coating steel roller 104 and the coating pressure roller 106 rotate in a clockwise direction and corresponding transfer rubber roller 103 and the coating rubber roller 105 rotate in a counterclockwise direction.

### Embodiment

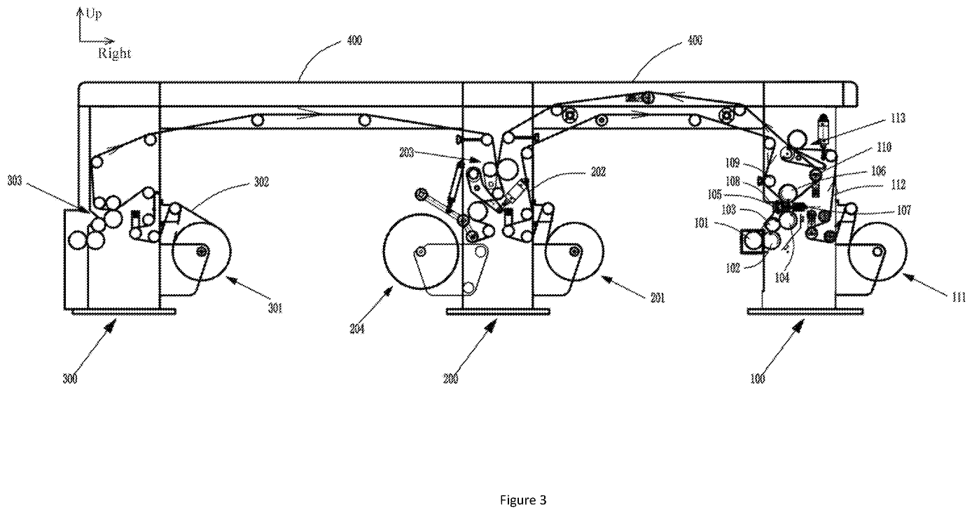

As shown in FIG. 3, a laminating machine, comprises a surface layer unreeling coating frame 300, a laminating reeling frame 200 and a coating laminating frame 100, wherein a surface layer unreeling mechanism 301, a surface layer coating assembly 303 and a surface layer material 302 are provided on the surface layer unreeling coating frame 300; a bottom layer unreeling mechanism 201, a bottom layer material 202, a second laminating portion 203 and a laminating unreeling mechanism 204 are provided on the laminating unreeling frame 200; the six-roller coating mechanism as shown in embodiment 1 is provided on the coating laminating frame 100; an intermediate layer unreeling mechanism 111, an intermediate layer material 112 and a first laminating portion 113 are provided on the base frame; wherein, the surface layer unreeling coating frame 300, the six-roller coating mechanism and the laminating frame are respectively connected with a bridge 400, with the bridge 400, connection between the laminating unreeling frame 200 and the coating laminating frame 100 is realized; and a tension roller 110 allowing the material roll to pass is provided in between the six-roller coating mechanism and the first laminating portion 113.

In the foregoing embodiment, the bottom layer material 202 enters the coating laminating frame 100 from the left side, and is coated by the six-roller coating mechanism, in the meanwhile, the intermediate layer material 112 is input into the first laminating portion 112 via the rollers, the bottom layer material 202 and one side of the intermediate layer material 112 are laminated by the first laminating portion 113, and transported to the laminating reeling frame 200 via the bridge 400; meanwhile, the surface layer material 302 on the surface layer unreeling coating frame 300 enters the laminating reeling frame 200 after being coated, and is laminated with another side of the intermediate layer material 112 by the second laminating portion 203, after laminating, the three-layer laminated material product will be obtained and reeling of the product can be done by the reeling mechanism.

### Embodiment

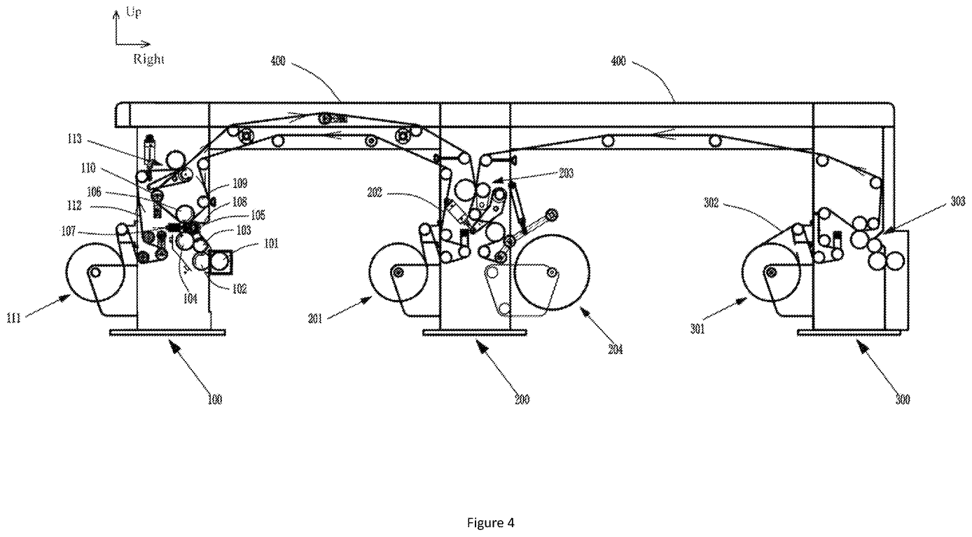

As shown in FIG. 4, a laminating machine, comprises a surface layer unreeling coating frame 300, a laminating reeling frame 200 and a coating laminating frame 100, a surface layer unreeling mechanism 301, a surface layer coating assembly 303 and a surface layer material 302 are provided on the surface layer unreeling coating frame 300; a bottom layer unreeling mechanism 201, a bottom layer material 202, a second laminating portion 203 and a laminating reeling mechanism are provided on the laminating reeling frame 200; the six-roller coating mechanism as shown in embodiment 2 is provided on the coating laminating frame 100; an intermediate layer unreeling mechanism 111, an intermediate layer material 112 and a first laminating portion 113 are provided on the base frame; wherein the surface layer unreeling coating frame 300, the six-roller coating mechanism and the laminating frame are respectively connected with the bridge 400, with the bridge 400 connection between the laminating reeling frame 200 and the coating laminating frame 100 is realized; and a tension roller 110 allowing the material roll to pass is provided in between the six-roller coating mechanism and the first laminating portion 113.

In the foregoing embodiment, the bottom layer material 202 enters the coating laminating frame 100 from the right side, is coated by the six-roller coating mechanism, in the meanwhile, the intermediate layer material 112 is inputted into the first laminating portion 113 via the rollers, the bottom layer material 202 and a side of the intermediate layer material 112 are coated by the first laminating portion 113 and then transported to the laminating reeling frame 200 via the bridge 400; meanwhile, the surface layer material 302 on the surface layer unreeling coating frame 300 enters the laminating reeling frame 200 after being coated, and is laminated with another side of the intermediate layer material 112 by the second laminating portion 203, after laminating, the final product of the three-layer laminating material is obtained, and reeling of the product is done by the reeling mechanism.

Finally it shall be explained that, the embodiments are merely used to explain the technical solution of the present invention rather than limit the same; although a detailed description is given to the present invention with reference to the foregoing embodiment, those of ordinary skill in the art shall appreciate that: it is still possible to modify the technical solutions recorded in the foregoing embodiments or replace all or some of the technical features with equivalents; and such modification or replacement does not deviate the essence of the technical solution from the scope of the technical solutions in the embodiments, and shall be covered in the protection scope of the claims and the specification of the present invention.

1. A six-roller coating mechanism, comprises a base frame, a metering roller (101), a transfer steel roller (102), a transfer rubber roller (103), a coating steel roller (104), a coating rubber roller (105), and a coating pressure roller (106), the coating rubber roller (105) is movably connected on the base frame via a linear motion mechanism (107) so to enable the coating rubber roller (105) to make linear movement on the base frame.

2. The six-roller coating mechanism according to claim 1, wherein the coating pressure roller (106) is connected on the base frame.

3. The six-roller coating mechanism according to claim 1, wherein a guiding portion is provided on the base frame, so that the coating rubber roller (105) is movable along the guiding portion and is abutted against the coating pressure roller (106) and the coating steel roller (104).

4. The six-roller coating mechanism according to claim 3, wherein the guiding portion comprises a guiding groove (108), and the coating rubber roller (105) is installed in the guiding groove (108); or the guiding portion comprises a guiding sliding rail and the coating rubber roller (105) is installed on the guiding sliding rail.

5. The six-roller coating mechanism according to claim 1, wherein, the mechanism further comprises an introduction roller (109) for inputting the material roll provided on the base frame next to the coating rubber roller (105).

6. The six-roller coating mechanism according to claim 5, wherein when the material roll enters the base frame from a left side, the transfer steel roller (102), the coating steel roller (104) and the coating pressure roller (106) rotate in a counterclockwise direction, and the transfer rubber roller (103) and the coating rubber roller (105) rotate in a clockwise direction.

7. The six-roller coating mechanism according to claim 5, wherein where the material roll enters the base frame from the right portion, the transfer steel roller (102), the coating steel roller (104) and the coating pressure roller (106) rotate in a clockwise direction, and the transfer rubber roller (103) and the coating rubber roller (105) rotate in a counterclockwise direction.

8. A laminating machine, wherein the laminating machine comprises the six-roller coating mechanism as recited in any of claims 1-6.

9. The laminating machine, wherein the laminating machine comprises: a surface unreel coating frame (300), comprising a surface layer unreeling mechanism (301), a surface layer coating assembly (303) and a surface layer material (302); a laminating reeling frame (200), comprising a bottom layer unreeling mechanism (201), a bottom layer material (202), a second laminating portion (203) and a laminating reeling mechanism (204); and a coating laminating frame (100), comprising the six-roller coating mechanism; comprising an intermediate layer unreeling mechanism (111), an intermediate layer material (112) and a first laminating portion (113); wherein the surface unreeling coating frame (300) and the six-roller coating mechanism are respectively connected with the laminating frame.

10. The laminating machine, wherein at least one tension roller (110) is provided in between the six-roller coating mechanism and the first laminating portion (113).
